(19) United States
(12) Patent Application Publication
(10) Pub. No.: US 2026/0177506 A1
(43) Pub. Date: Jun. 25, 2026

(54) NOZZLE CONTACT-CHECKING DEVICE USING WAVEGUIDED LIGHT

(71) Applicant: KOREA ELECTROTECHNOLOGY RESEARCH INSTITUTE, Changwon-si Gyeongsangnam-do (KR)

(72) Inventors: Jae Yeon PYO, Changwon-si (KR); Seung Kwon SEOL, Changwon-si (KR); Chan Bin YOO, Changwon-si (KR)

(73) Assignee: KOREA ELECTROTECHNOLOGY RESEARCH INSTITUTE, Changwon-si Gyeongsangnam-do (KR)

(21) Appl. No.: 19/125,934

(22) PCT Filed: Nov. 2, 2023
(86) PCT No.: PCT/KR2023/017333

§ 371 Date: Apr. 30, 2025

(30) Foreign Application Priority Data
Nov. 2, 2022 (KR) 10-2022-0144490

(51) Int. Cl. G01N 21/95; B41J 2/045; G01N 21/88

(52) U.S. Cl. CPC G01N 21/9501; B41J 2/04581; G01N 21/8806

(57) ABSTRACT

A nozzle contact-checking device using waveguided light comprising: a nozzle, the interior of which forms a through-hole along a length-wise direction and which is provided with an outlet at one end, and walls of which function as an optical waveguide; an inspection light-emitting unit for emitting inspection light to the nozzle from the rear or oblique rear side of the nozzle; and an imaging unit for capturing at least one end of the nozzle and generating captured images.

### TECHNICAL FIELD

Embodiments of the present disclosure relate to a device for checking contact of a nozzle, and in particular, to a device for checking whether the nozzle is in contact by sensing a phenomenon in which scattered light disappears at an end of a nozzle that functions as an optical waveguide.

### BACKGROUND ART

Nozzles, in particular, fine nozzles, have been used as important tools in life sciences, analytical chemistry, nano-3D printing and the like for handling micro- or nano-level samples and the like.

The fine nozzles may be fabricated by processing a glass capillary, and in this case, since an end of the fine nozzle is easily broken due to the material properties, attention is required for handling. Therefore, it is preferable to take subsequent or countermeasure measures immediately upon checking the state or point in time at which the end of the nozzle contacts a substrate or the like in actual utilization.

Examples of a method for checking whether or not the fine nozzle is in contact include a method of observing contact in real time using an optical microscope, a method of checking contact by a mechanical signal such as a resonance phenomenon of a nozzle, and the like, and a method of checking contact by an electrical signal such as energization or current change, and the like.

However, there is a technical limit to the conventional nozzle contact-checking method. The method using an optical microscope may check the position of a fine nozzle in real time, but is difficult to apply to nano-level fine nozzles due to a resolution limitation according to a diffraction limit of the optical microscope. The method of checking contact by a mechanical signal involves movement of the nozzle for checking contact, and thus there is a problem in that a sample filled in the nozzle is damaged or delicate contact is limited. The method of checking contact by an electrical signal has a limitation in the range of utilization due to an electrical conductivity of a sample to be utilized.

### DETAILED DESCRIPTION OF THE INVENTION

### Technical Problem

Embodiments of the present disclosure aim to provide a nozzle contact-checking device that may also be utilized for nano-level fine nozzles.

In addition, embodiments of the present disclosure aim to provide a nozzle contact-checking device that is not limited to whether a sample or an object (a substrate, a bed, or the like) is energized and thus has a wide application range, and is not accompanied by vibration, heat generation, or the like and thus does not affect operation such as analysis and manufacturing.

### Technical Solution

In the embodiments of the present disclosure, the nozzle contact-checking device using waveguided light may include a nozzle, an inspection light-emitting unit, an imaging unit, and the like.

At this time, the interior of the nozzle forms a through-hole along a length-wise direction and which is provided with an outlet at one end, and walls of which function as an optical waveguide, and the inspection light-emitting unit may emit inspection light to the nozzle from the rear or oblique rear side of the nozzle.

The imaging unit may capture one end of the nozzle provided with an outlet and generate captured images.

A nozzle contact-checking device using waveguided light according to an embodiment of the present disclosure may include a control unit. The control unit may analyze the captured images received from the imaging unit to determine whether scattered light disappears.

The control unit of the nozzle contact-checking device using waveguided light according to an embodiment of the present disclosure may determine whether an intensity of a scattered light spot decreases below a threshold in the captured images.

The control unit of the nozzle contact-checking device using waveguided light according to an embodiment of the present disclosure may set the threshold to 90% of the initial intensity of the scattered light spot.

The control unit of the nozzle contact-checking device using waveguided light according to an embodiment of the present disclosure may set the threshold to 50% of the initial intensity of the scattered light spot.

The control unit of the nozzle contact-checking device using waveguided light according to an embodiment of the present disclosure may separate the nozzle from an object when the scattered light disappears.

The nozzle of the nozzle contact-checking device using waveguided light according to an embodiment of the present disclosure may be a fine nozzle obtained by processing a glass capillary.

The nozzle contact-checking device using waveguided light according to an embodiment of the present disclosure may include a lighting unit for emitting imaging light toward the object on an opposite side of the imaging unit with the nozzle interposed therebetween.

### Advantageous Effects

According to the embodiments of the present disclosure, the presence/absence of scattered light is checked to determine whether the nozzle is in contact, so that it is possible to accurately determine whether the nozzle in contact even in a fine region having a size much smaller than that of an optical microscope, that is, a nano size.

In addition, since the scattered light generated at one end where waveguided light transmitted along walls of a fine nozzle forms an interface with the air is used, the application range of the sample, the object, and the like may be expanded without being limited to whether the sample, the object, and the like are energized.

In addition, the nozzle contact-checking device using waveguided light according to the present embodiment is not accompanied by vibration or heat generation, and thus does not affect (impede, interrupt, or the like) operation such as analysis and manufacturing.

In particular, the nozzle contact-checking device using waveguided light according to the present embodiment may be broadly applied to life sciences, analytical chemistry, nanotechnology, and the like, and may be particularly usefully applied to nano-3D printing, which has recently been in the spotlight. In nano-3D printing, a sample (coating material) is ejected by using a fine nozzle, and in nano-level high-resolution printing, a problem in which the nozzle is damaged due to excessive contact between the nozzle and an object (a substrate, a bed, or the like) may occur, and it is necessary for the nozzle to check contact of the substrate. Utilizing the nozzle contact-checking device using waveguided light according to the present disclosure in the field of nano-3D printing may easily solve the problem of such contact.

### BRIEF DESCRIPTION OF THE DRAWINGS

FIG. 1 illustrates a nozzle contact-checking device using waveguided light according to an embodiment of the present disclosure.

FIG. 2 is an imaging unit that captures a phenomenon in which scattered light disappears at one end of a nozzle using the nozzle contact-checking device using waveguided light according to an embodiment of the present disclosure.

FIG. 3 is a flowchart describing a process of checking nozzle contact using the nozzle contact-checking device using waveguided light according to an embodiment of the present disclosure.

FIG. 4 illustrates a modification example of the nozzle contact-checking device using waveguided light according to an embodiment of the present disclosure.

### BEST MODE FOR CARRYING OUT THE INVENTION

Hereinafter, some embodiments of the present disclosure will be described in detail with reference to illustrative drawings. In adding reference numerals to components in each drawing, the same components may have the same numerals as much as possible even if they are displayed on different drawings. In addition, in describing the present disclosure, when it is determined that a specific description of a related known configuration or function may obscure the gist of the present disclosure, a detailed description thereof may be omitted. When “comprise,” “have,” “consist of” and the like mentioned in this specification are used, other parts may be added unless “only” is used. The singular forms “a,” “an,” and “the” include plural referents unless the context clearly dictates otherwise.

In addition, the terms “first,” “second,” “A,” “B,” “(a),” “(b),” and the like may be used to describe the components of the present disclosure. These terms are only used to distinguish the components from other components, and the nature, sequence, order, number, or the like of the components is not limited by these terms.

In the description of the positional relationship between components, when two or more components are described as being “linked,” “coupled,” “connected,” or the like, it should be understood that the two or more components may be directly “linked,” “coupled,” or “connected,” but two or more components and another component may also be further “interposed” to be “linked,” “coupled,” or “connected.” Here, other components may be included in one or more of the two or more components that are “linked,” “coupled,” or “connected” to each other.

In the description of the temporal flow relationship related to the components, an operation method, a manufacturing method, and the like, for example, the case where the temporal or flow precedence relationship is described as “after,” “following,” “next,” “before,” or the like may include the case where the relationship is not continuous unless “immediately” or “directly” is used.

On the other hand, when a numerical value or corresponding information (e.g., a level or the like) for a component is mentioned, the numerical value or the corresponding information may be interpreted as including an error range that may be caused by various factors (e.g., a process factor, an internal or external shock, noise, or the like), even if there is no separate explicit description.

Various embodiments of the present disclosure will now be described in detail with reference to the accompanying drawings.

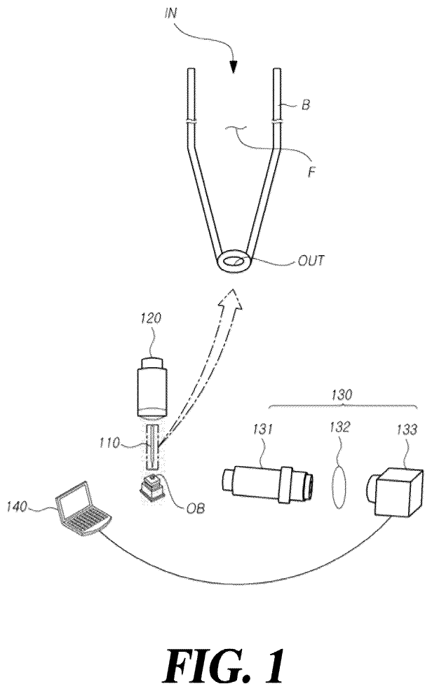

FIG. 1 illustrates a nozzle contact-checking device using waveguided light according to an embodiment of the present disclosure.

As shown in FIG. 1, the nozzle contact-checking device using waveguided light according to an embodiment of the present disclosure may include a nozzle 110, an inspection light-emitting unit 120, an imaging unit 130, a control unit 140, and the like.

The nozzle 110 moves a sample, a coating material, or the like (hereinafter, collectively referred to as a “sample”), and may be configured as a tube having cylindrical walls B that form a communication flow path F along a length-wise direction therein.

The nozzle 110 may include an inlet IN through which a sample is injected and an outlet OUT through which the sample is discharged.

The nozzle 110 may have an overall shape that decreases in width from the inlet IN toward the outlet OUT.

The nozzle 110 may have a cylindrical shape in an inlet IN region and a tapered shape in an outlet OUT region. The outlet OUT region of the nozzle 110 may have a shape in which the width of the flow path F continuously narrows toward an end. In the region of the tapered outlet OUT, the thickness of the walls B may be configured to decrease toward the end of the outlet OUT.

The nozzle 110 may function as an optical waveguide that propagates light along the walls B. To this end, the nozzle 110 may be made of glass, plastic, or the like, which is a transparent material capable of guiding wave.

The nozzle 110 may be, for example, a nano-level fine nozzle having the outlet OUT with a diameter of 500 nm or less, and in this case, the sample may move along the flow path by capillary action.

The nozzle 110 may be used in a form in which the inlet IN is configured in an open form and the sample is directly introduced into the inlet IN, and in this case, when light is guided to the nozzle 110, inspection light may be emitted from the direction of the inlet IN to coincide with the length-wise direction of the nozzle 110.

The inspection light-emitting unit 120 emits the inspection light to the nozzle 110 and may be used without limitation as long as it generates light.

The inspection light-emitting unit 120 may emit the inspection light to the nozzle 110 from the rear in the inlet IN direction or obliquely from the rear side. The inspection light emitted on the nozzle 110 propagates from the rear to the front along the walls B of the nozzle 110, and may be scattered at the front end, i.e., the outlet OUT, of the nozzle 110. The scattered light generated at the outlet OUT of the nozzle 110 may shine brighter than the waveguided light WL propagating through the nozzle 110 walls B while forming spot light. The intensity of the spot light may be greater than the intensity of the waveguided light WL of the walls B as the outlet OUT region of the nozzle 110 is tapered to form the outlet OUT diameter smaller than the wall B diameter.

The imaging unit 130 generates captured images by capturing the outlet OUT region of the nozzle 110, and may include an objective lens 131, a tube lens 132, a CCD camera 133, and the like.

The objective lens 131 may be positioned in the direction of the outlet OUT of the nozzle 110 by projecting (or enlarging) an image to infinity.

The tube lens 132 forms an image at the position of the CCD camera 133, and may be positioned between the objective lens 131 and the CCD camera 123.

The CCD camera 133 generates the captured images, and may be positioned at a point where the image is formed by the tube lens 132. The CCD camera 133 may include a charge coupled device (CCD) that converts light intensity into an electrical signal, converts incoming light into an electrical signal (analog signal) according to light intensity, converts the electrical signal into a digital signal through an analog-digital converter (ADC), and then stores the digital signal in a memory. The captured images generated by the CCD camera 133 may be displayed in real time through a display, and in this case, it is also possible for an examiner to directly determine whether or not the scattered light disappears.

The control unit 140 analyzes the captured images received from the imaging unit 130 to determine whether the nozzle 110 is in contact with an object OB, and if necessary, instructs a subsequent process, and may be connected to the imaging unit 130, a nozzle driving unit (not shown), or the like.

The control unit 140 may determine that the nozzle 110 is in contact with the object OB when the scattered light disappears in the region of the outlet OUT of the nozzle 110 in the captured images. The scattered light may be identified (specified) in the imaging unit as light in the form of a spot in the outlet OUT region of the nozzle 110, and the specified spot light SL has a higher intensity of light than other regions in the captured images and may appear in a circular shape.

The control unit 140 may track the light intensity of the specified scattered light, that is, the spot light SL, in real time, and determine whether light intensity of the spot light SL falls below a set threshold, and when the light intensity falls, determine that the spot light SL, that is, scattered light, has disappeared. Here, the threshold (e.g., threshold intensity) may be set to 90% of an initial intensity of the spot light SL, but the threshold may also be set lower depending on the capturing environment, the size of a binary large object (BLOB), or the like. In the case where the threshold is set to be lower, the threshold may be set to about 50% of the initial intensity of the spot light SL, and in this case, even in a worst-case environment, an extinction determination error of the spot light S L may be kept at 1% or less.

When it is determined that the scattered light disappears and the nozzle 110 comes into contact with the object OB, the control unit 140 may selectively instruct the subsequent process. Here, the subsequent process may be, for example, an operation of moving the nozzle 110 rearward to separate the nozzle 110 from the object OB in a nano-3D printer. In this process, the control unit 140 may transmit a separation (retraction) instruction to the nozzle driving unit (not shown), such as an arm stage.

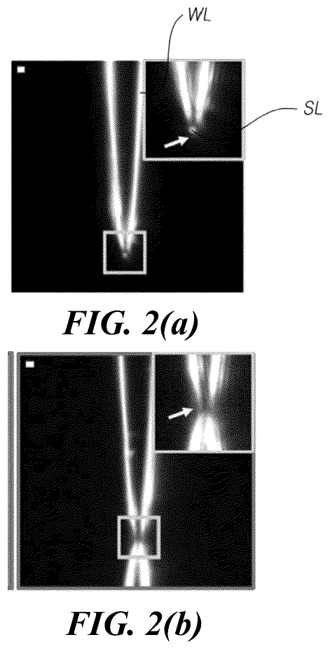

FIG. 2 is the imaging unit that captures a phenomenon in which the scattered light disappears at one end of the nozzle using the nozzle contact-checking device using waveguided light according to an embodiment of the present disclosure.

As shown in FIG. 2(a), when the inspection light-emitting unit 120 emits the inspection light in the inlet IN direction from the rear of the nozzle 110, the inspection light propagates in the outlet OUT direction from the rear to the front along the walls B of the nozzle 110. At this time, the scattered light may be generated as the inspection light is scattered at the front end of the nozzle 110 where the inspection light meets the air, that is, in the outlet OUT region.

As shown in FIG. 2(a), the scattered light may shine brightly in the outlet OUT region of the nozzle 110 while forming the spot light SL in the form of dots. The size of the spot light SL may be proportional to the diameter of the outlet OUT, and the intensity of the spot light S L may be proportional to a difference between a diameter of the nozzle 110 and a diameter of the outlet OUT, an intensity of the inspection light, or the like.

As shown in FIG. 2(b), it may be checked that the scattered light, that is, the spot light SL in the form of dots disappears as the front end of the nozzle 110, that is, the outlet OUT, hits the object OB. Based on such a phenomenon, if the spot light SL is specified in the captured images and it is checked that the spot light DL disappears, it is possible to indirectly check whether the nozzle 110 is in contact with the object OB.

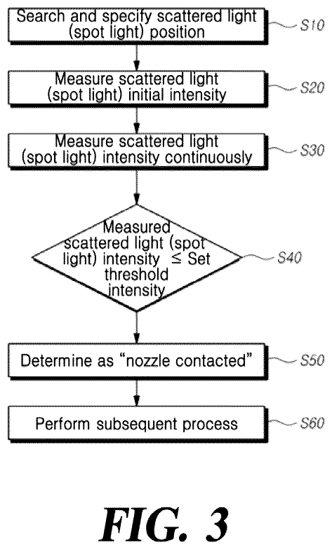

FIG. 3 is a flowchart describing a process of checking nozzle contact using the nozzle contact-checking device using waveguided light according to an embodiment of the present disclosure.

As illustrated in FIG. 3, in the process of checking contact of the nozzle 110 using the nozzle contact-checking device using waveguided light according to an embodiment of the present disclosure, first, in step S10, the position of the scattered light, that is, the spot light SL may be searched for and specified.

The spot light SL is searched from a lower end of the captured image upward based on the structural characteristics of the nozzle 110, and the shape of the outlet OUT of the nozzle 110, the shape of light, an intensity of the light, and the like may be checked. In this process, light in the form of dots having higher intensity than other regions may be specified as the scattered light, i.e., the spot light SL.

In step S20, an initial intensity (e.g., luminous intensity) of the specified spot light SL may be measured. The initial intensity (luminous intensity) of the spot light SL may be, for example, 42,000 cd.

In step S30, an intensity change of the spot light SL may be tracked while continuously measuring the intensity of the specified spot light SL. Here, tracking the intensity change of the spot light SL may be performed by BLOB processing of a spot light region in the captured image.

In step S40, it is determined whether a measured intensity becomes lower than the threshold intensity while continuously comparing the measured intensity of the specified spot light SL with the set threshold intensity. Here, the threshold intensity may vary depending on the capturing environment or the BLOB size, but is usually based on image processing, and thus may be reliably measured even with a brightness reduction of 10% compared to the initial intensity, so that it is possible to set the threshold intensity to 90% of the initial intensity. However, since it may be difficult to detect a change in a spot intensity due to the influence of the capturing environment and the size of the BLOB, the set intensity may be set to be reduced to 50% of the initial intensity, but the determination error may be maintained at 1% or less in any environment with the set intensity of such level.

In step S50, if the measured intensity becomes lower than the threshold intensity, the control unit 140 may determine that the nozzle 110 has contacted the object OB.

Then, in step S60, the control unit 140 may further perform the subsequent process. For example, in the case of a nano-3D printer, when it is determined that the nozzle 110 is in contact with the object OB, an additional approach of the nozzle 110 may be stopped or retracted to prevent damage to the nozzle 110 or the object OB. Further, by allowing a printing process to be continuously performed while separating the nozzle 110 from the object OB, it is possible to provide continuity of the printing process and uniform printing quality. This effect may effectively solve various problems in the actual nano printing process, such as interruption of the printing process after contact of the nozzle 110 with the object OB, spreading of ink on the surface of the object OB due to delay, uneven surface due to evaporation, and clogging of the nozzle.

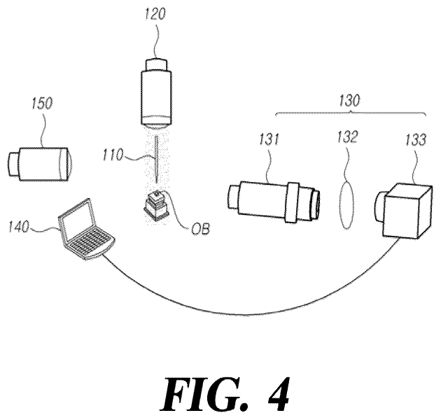

FIG. 4 illustrates a modification example of the nozzle contact-checking device using waveguided light according to an embodiment of the present disclosure.

As shown in FIG. 4, the modification example of the nozzle contact-checking device using waveguided light according to an embodiment of the present disclosure may further include a lighting unit 150.

The lighting unit 150 is provided on an opposite side of the imaging unit 130 with the nozzle 110 and the object OB interposed therebetween, and may emit imaging light toward the object OB. The imaging light may be used to check the nozzle 110 and the object OB, and further to check and control a relative movement of the nozzle 110 and the object OB.

Since the nozzle contact-checking device using waveguided light according to an embodiment of the present disclosure having such a configuration and action/function uses the waveguided light WL propagating along the walls of the nozzle 110 and the scattered light generated at the interface between the nozzle 110 and air, not only a transparent liquid sample but also an opaque liquid sample may be used as the sample injected into the nozzle 110, and further, it may be applied to the nozzle 110 that is empty.

The foregoing descriptions are merely illustrative of the technical concept of the present disclosure, and various modifications and changes may be made by those skilled in the art without departing from the essential characteristics of the present disclosure. In addition, the embodiments disclosed in the present disclosure are not intended to limit the scope of the technical concept of the present disclosure, but are intended to be illustrative. The protection scope of the present disclosure should be interpreted by the following claims, and all technical concept within the scope equivalent thereto should be interpreted as being included in the scope of rights of the present disclosure.

### DESCRIPTION OF SIGNS

110: Nozzle
120: Inspection light-emitting unit
130: Imaging unit
131: Objective lens
132: Tube lens
133: CCD camera
140: Control unit
150: Lighting unit
OB: Object
B: Nozzle walls
F: Nozzle flow path
IN: Nozzle inlet
OUT: Nozzle outlet
WL: Waveguided light
SL: Spot light

1. A nozzle contact-checking device using waveguided light, comprising:
a nozzle, the interior of which forms a through-hole along a length-wise direction and which is provided with an outlet at one end, and walls of which function as an optical waveguide;
an inspection light-emitting unit for emitting inspection light to the nozzle from the rear or oblique rear side of the nozzle; and
an imaging unit for capturing at least one end of the nozzle and generating captured images,
wherein, the inspection light is propagated along the walls from the rear of the nozzle toward the outlet.

2. The nozzle contact-checking device of claim 1, comprising a control unit for analyzing the captured images received from the imaging unit to determine whether scattered light, generated as the inspection light is scattered at the outlet, disappears at the one end of the nozzle.

3. The nozzle contact-checking device of claim 2, wherein the control unit determines whether an intensity of a scattered light spot decreases below a threshold in the captured images.

4. The nozzle contact-checking device of claim 3, wherein the control unit sets the threshold based on an initial intensity of the scattered light spot.

5. (canceled)

6. The nozzle contact-checking device according to claim 2, wherein the control unit stops further approach of the nozzle toward the object when the scattered light disappears.

7. The nozzle contact-checking device of claim 1, wherein the nozzle is fabricated by processing a glass tube.

8. The nozzle contact-checking device of claim 1, comprising:
a lighting unit for emitting imaging light toward the object on an opposite side of the imaging unit with the nozzle interposed therebetween.

9. The nozzle contact-checking device according to claim 3, wherein the control unit stops further approach of the nozzle toward the object when the scattered light disappears.

10. The nozzle contact-checking device according to claim 4, wherein the control unit stops further approach of the nozzle toward the object when the scattered light disappears.

11. The nozzle contact-checking device according to claim 5, wherein the control unit stops further approach of the nozzle toward the object when the scattered light disappears.
